(19) United States
(12) Patent Application Publication
(10) Pub. No.: US 2005/0142403 A1
(43) Pub. Date: Jun. 30, 2005

(54) Fuel cell system

(76) Inventors: Kurt Ulmer, Corvallis, OR (US); Gregory Herman, Albany, OR (US); Peter Mardilovich, Corvallis, OR (US); David Punsalan, Eugene, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/749,751

(22) Filed: Dec. 30, 2003

(51) Int. Cl. H01M 8/06; H01M 8/12; H01M 8/04

(52) U.S. Cl. 429/19; 429/30; 429/26; 429/17; 429/20

(57) ABSTRACT

A fuel cell systems and methods involving decomposing an inorganic oxygen containing salt that decomposes into oxygen and a non-volatile salt and/or mixing fuel cell reaction byproducts with an absorbent material that endothermically reacts with the fuel cell reaction byproducts.

### BACKGROUND OF THE INVENTIONS

1. Field of the Inventions

The present inventions are related to fuel cell systems.

2. Description of the Related Art

Fuel cells, which convert reactants (i.e. fuel and oxidant) into electricity and reaction products, are advantageous because they are not hampered by lengthy recharging cycles, as are rechargeable batteries, and are relatively small and lightweight. Nevertheless, the present inventors have determined that conventional fuel cells are susceptible to improvement. For example, ambient air is not available in many instances and oxidant (typically oxygen) must be stored in compressed form within the fuel cell system or host device. The present inventors have determined that because oxygen in the gas phase has relatively low density, large volumes of oxygen must be stored when the fuel cell is using relatively high energy density fuels such as hydrocarbons. The present inventors have also determined that the use of fuel cells which operate at a relatively high temperature (e.g. 200° C. and above) and/or produce relatively humid exhaust can present a variety of challenges. Extensive insulation is required to protect users and other devices from the heat, while the high levels of humidity can result in significant condensation as the exhaust cools. These issues are magnified in closed systems, including some military applications, where the exhaust from the fuel cell cannot be vented and heat cannot be detectable.

### SUMMARY OF THE INVENTIONS

An apparatus in accordance with one of the present inventions includes a fuel cell and an oxygen supply operably connected to the fuel cell. The oxygen supply may, for example, include an inorganic oxygen containing salt that decomposes into oxygen and a non-volatile salt.

A method in accordance with one of the present inventions includes the steps of decomposing an inorganic oxygen containing salt into oxygen and a non-volatile salt and supplying the oxygen to a fuel cell.

An apparatus in accordance with one of the present inventions includes a fuel cell and means, operably connected to the fuel cell, for decomposing an inorganic oxygen containing salt into oxygen and a non-volatile salt.

An apparatus in accordance with one of the present inventions includes a power consuming device and a fuel cell system. The fuel cell system may include a fuel cell, a fuel supply, and an oxygen supply with an inorganic oxygen containing salt that decomposes into oxygen and a non-volatile salt.

An apparatus in accordance with one of the present inventions includes a fuel cell and a waste products storage device. The waste products storage device may include an absorbent material that endothermically reacts with byproducts from the fuel cell.

A method in accordance with one of the present inventions includes the steps of transferring fuel cell reaction byproducts to a waste products storage device and mixing the fuel cell reaction byproducts with an absorbent material that endothermically reacts with the byproducts.

An apparatus in accordance with one of the present inventions includes a fuel cell and means for receiving byproducts from the fuel cell, using the byproducts in an endothermic reaction, and storing all products of the endothermic reaction.

An apparatus in accordance with one of the present inventions includes a power consuming device and a fuel cell system. The fuel cell system may include a fuel cell and a waste products storage device, operably connected to the fuel cell, including an absorbent material that endothermically reacts with byproducts from the fuel cell.

### BRIEF DESCRIPTION OF THE DRAWINGS

Detailed description of embodiments of the inventions will be made with reference to the accompanying drawings.

FIG. 1 is a diagrammatic view of a fuel cell system in accordance with an embodiment of a present invention.

FIG. 2 is a section view of a fuel cell that may be employed in the system illustrated in FIG. 1.

FIG. 3 is a section view of an oxidant supply in accordance with an embodiment of a present invention.

FIG. 4 is a section view taken along line 4-4 in FIG. 3.

FIG. 5 is a diagrammatic view of a power consuming apparatus in accordance with an embodiment of a present invention.

FIG. 6 is a diagrammatic view of a fuel cell system in accordance with an embodiment of a present invention.

FIG. 7 is a diagrammatic view of a fuel cell system in accordance with an embodiment of a present invention.

### DETAILED DESCRIPTION OF THE EMBODIMENTS

The following is a detailed description of the best presently known modes of carrying out the inventions. This description is not to be taken in a limiting sense, but is made merely for the purpose of illustrating the general principles of the inventions. It is noted that detailed discussions of fuel cell structures that are not pertinent to the present inventions have been omitted for the sake of simplicity. The present inventions are also applicable to a wide range of fuel cell technologies and fuel cell systems, including those presently being developed or yet to be developed. For example, although various exemplary fuel cell systems are described below with reference to solid oxide fuel cells (“SOFCs”), other types of fuel cells, such as molten carbonate fuel cells, are equally applicable to the present inventions. Also, although the exemplary fuel cells described below are multi-chamber fuel cells, the present inventions are also applicable to single chamber fuel cells.

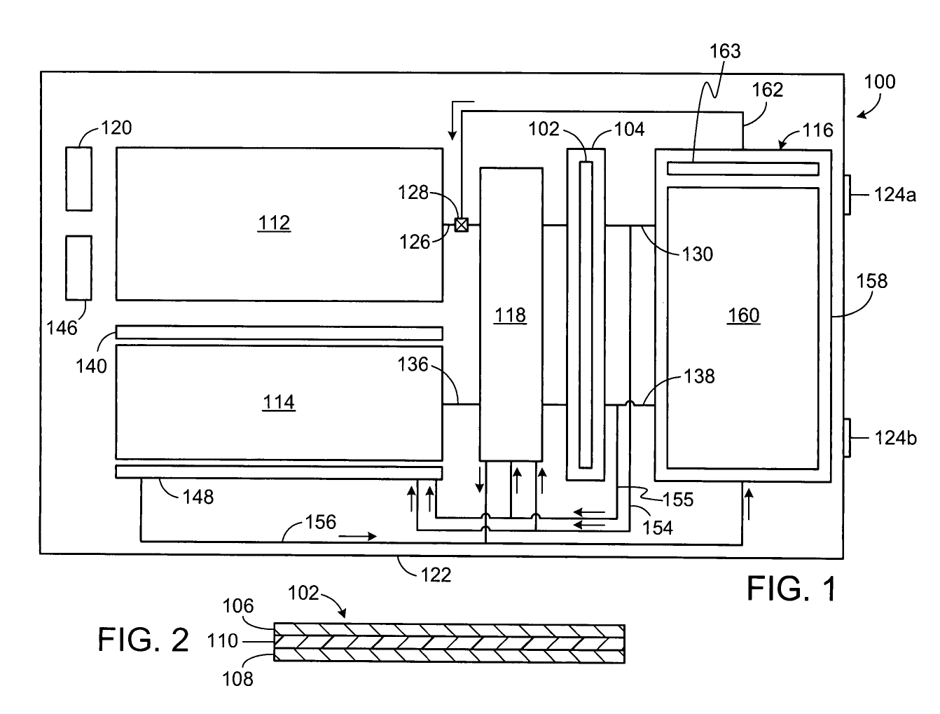

As illustrated for example in FIGS. 1 and 2, a fuel cell system 100 in accordance with one embodiment of a present invention includes one or more fuel cells 102 packaged in housing 104. The exemplary fuel cell 102, which is an SOFC, includes an anode 106 and a cathode 108 separated by an electrolyte 110. Current collectors (not shown) are respectively associated with the anode 106 and cathode 108. The anode 106 and cathode 108, on opposing faces of the electrolyte 110, are each composed of a thin catalyst layer and, optionally, a gas diffusion layer. A fuel supply 112 supplies fuel, e.g. hydrocarbon fuels such as methane (CH₄), ethane (C₂H₆), propane (C₃H₈) etc., to the anode 106 by way of a manifold (not shown) in the housing 104 and an oxidant supply 114 supplies oxidant, such as oxygen (O₂), to the cathode 108 by way of a manifold (not shown) in the housing. The fuel is electrochemically oxidized at the anode catalytic surface, reacting with O²⁻ ions that were produced by the reaction of O₂ with the cathode catalytic surface and diffused across the O²⁻ conducting electrolyte 110. The reaction at the anode produces byproducts, i.e. water vapor (H₂O) and carbon dioxide (CO₂) in the exemplary embodiment. In those instances where a plurality of fuel cells are arranged in a stack, the current collectors of the individual fuel cells may be connected to one another in series or parallel depending on the load.

The exemplary fuel cell system 100 is also provided with a waste products storage device 116, which may be used to store byproducts from the fuel cell 102, and a heat exchanger 118, which may be used to heat the reactants before they reach the fuel cell 102. In some instances, unused reactants may also be stored. A controller 120 may be provided to monitor and control the operations of the exemplary fuel cell system 100. Alternatively, the operation of the fuel cell system may be controlled by the host (i.e. power consuming) device. The system components described above are located within a housing 122, which is preferably insulated, and a pair of electrical contacts 124a and 124b are associated with the exterior of the housing.

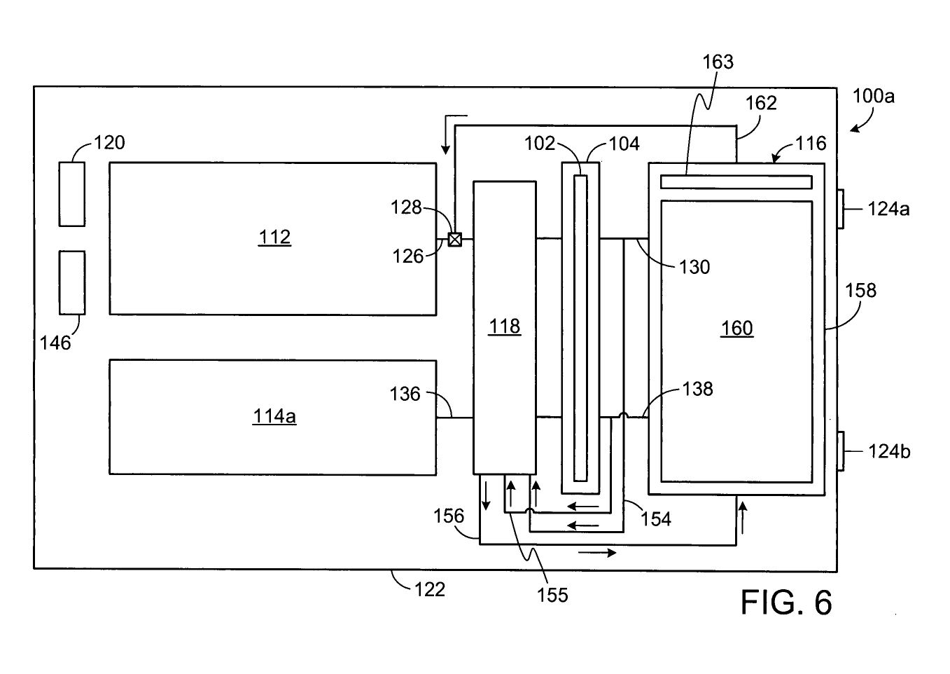

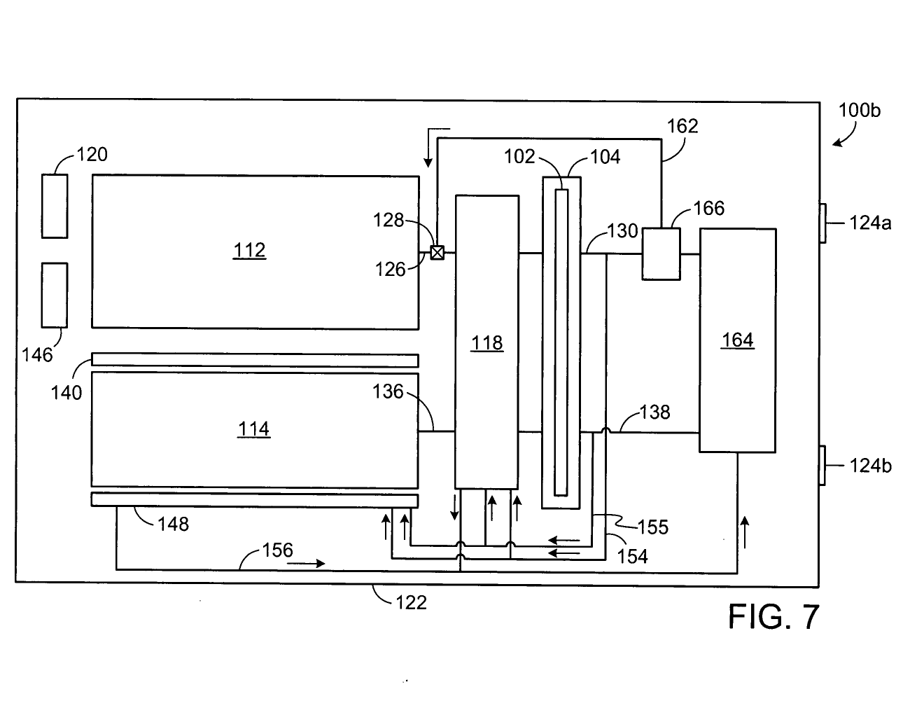

The exemplary fuel cell system 100 is a “closed” system and, to that end, the fuel supply 112, oxidant supply 114 and housing 122 are not configured to permit removal and replacement of the fuel and oxidant supplies. All of the reactants that will be consumed by the “closed” system are initially present in the system. The storage device 116 will also remain in the housing 122 and, to that end, all of the byproducts generated by the fuel cell reaction (as well as any unused reactants that pass through the fuel cell) will remain within the housing. Alternative fuel cell system configurations in accordance with the present inventions, which may be “open” to various degrees, are discussed below with reference to FIGS. 6 and 7.

Referring more specifically to the manner in which reactants are stored in the exemplary fuel cell system 100, and as noted above, the fuel and oxidant supplies 112 and 114 are located within the housing 122. The respective configurations of the fuel and oxidant supplies 112 and 114 will depend on the manner in which the fuel and oxidant is stored. In the exemplary system 100 illustrated in FIGS. 1 and 2, the fuel supply 112 is a pressurized fuel storage device, such as that illustrated in U.S. patent Pub. No. 2003/0136453 A1. The pressure forces the fuel through an anode inlet line 126. A valve 128 may be provided so that the supply of fuel can be stopped when the fuel cell system is not operating and the quantity of fuel can be precisely metered, based on the load, when the system is operating. Anode-side byproducts and unused reactant (if any) are transferred to the waste products storage device 116 through an outlet line 130.

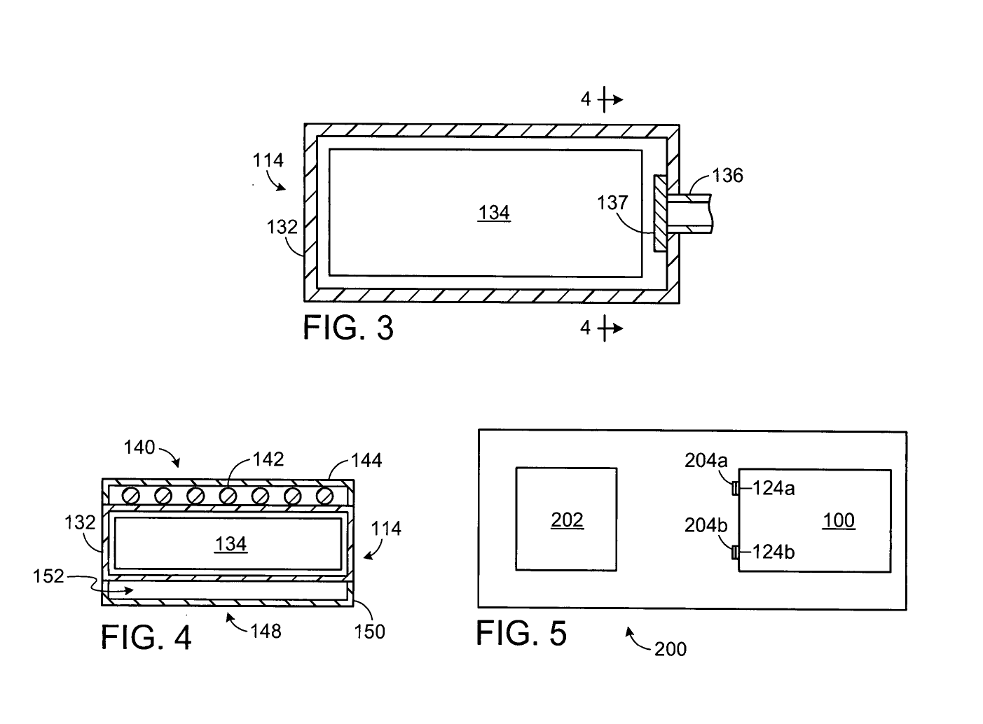

Turning to FIGS. 3 and 4, the exemplary oxidant supply 116 includes a housing 132 in which an oxygen producing material 134 is stored. The oxygen producing material in the exemplary implementation is an inorganic oxygen containing salt that will decompose into O₂ and a non-volatile salt when heated. One example of an inorganic oxygen containing salt is a metal chlorate, and preferably an alkali metal chlorate, such as potassium chlorate (KClO₃), sodium chlorate (NaClO₃) or lithium chlorate (LiClO₃). Other examples include metal perchlorates, such as potassium perchlorate (KClO₄) and sodium perchlorate (NaClO₄), and metal permanganates, such as potassium permanganate (KMnO₄). The inorganic oxygen containing salt may be stored in solid form such as, for example, a thick film on a porous medium that is capable of being heated and cooled in the manner described below.

As noted above, one example of an inorganic oxygen containing salt is a metal chlorate. Metal chlorates will decompose when heated to about 400° C. into a metal chloride and O₂, e.g. 2KClO₃→2KCl+3O₂. Metal chlorates also have relatively high oxygen content, e.g. 1 g of KClO₃ has 0.39 g of O₂. A solid metal chloride will remain within the housing 132 after the decomposition, and O₂ will be forced out of the oxidant supply 114, and through a cathode inlet line 136, due to the pressure buildup within the housing. A filter membrane 137 (FIG. 3) that only allows the O₂ to pass may be positioned within the housing 132 adjacent to the inlet line 136. Cathode-side byproducts and unused reactant (if any) are transferred to the waste products storage device 116 through an outlet line 138 (FIG. 1).

There are a number of advantages associated with supplying O₂ in this manner. By way of example, but not limitation, supplying O₂ in this manner allows fuel cells to perform better in situations where ambient air is not available, such as underwater and high altitude applications and those instances where the fuel cell is carried in an airtight container or used in an inert atmosphere. Supplying O₂ in this manner also provides substantial volumetric savings, e.g. 1 cm³ of KClO₃ produces 639 cm³ of O₂ at 25° C. and 1 atmosphere.

The heat for the decomposition of the metal chlorate or other inorganic oxygen containing salt may be provided in a variety of ways, both at startup and after fuel cell operation has begun. In the exemplary implementation illustrated in FIGS. 3 and 4, heat is provided at startup by a parasitic heater 140, i.e. a heater which consumes energy stored in the fuel cell system 100. The exemplary parasitic heater 140, which may also be used to regulate the amount of heat that is supplied to the oxygen producing material 134 in the manner described below, is a resistive heater that includes a plurality of resistors 142 in a housing 144. The heater 140 is powered by a battery 146 that is recharged by the fuel cell 102 during fuel cell operations. The battery 146 may also be used to power the controller 120. The resistors 142 are carried on the exterior of the housing 132 and, accordingly, the housing 132 should be formed from material that is relatively high in thermal conductivity.

The parasitic heater 140 may, alternatively, be a fuel burning heater that burns fuel from the fuel supply 112. Other types of heaters that may be used to provide heat for the decomposition reaction include, for example, microcatalytic combustors, ignition heaters and heat pipes.

Once the fuel cell reaction has started, heat for the decomposition of the inorganic oxygen containing salt is provided by a heater 148 (FIG. 4) that uses the byproducts from the fuel cell anode and cathode chambers. The exemplary heater 148 is a catalytic combustor which includes a housing 150 that encloses an interior region 152 in which catalytic material (not shown) is located. Referring to FIG. 1, the heater 148 receives some of the byproducts and unused reactants (if any) from the anode-side outlet line 130, which are burned to produce heat, by way of an inlet line 154. The heater 148 also receives some of the byproducts and unused reactants (if any) from the cathode-side outlet line 138 by way of an inlet line 155. The output from the heater 148 is transferred to the waste products storage device 116 through an outlet line 156.

The heater 148 may, alternatively, be a heat exchanger that draws heat from the fuel cell exhaust. The exhaust may be from the anode, the cathode or both. Other exemplary heaters include microcatalytic combustors, ignition heaters and heat pipes.

Regardless of the type of heater employed, the heater 148 may be configured in some embodiments of the inventions such that the amount of heat supplied to the oxygen producing material 134 (e.g. the inorganic oxygen containing salt) will be slightly less heat than the amount of heat required to cause substantial decomposition into non-volatile salt and O₂. The additional heat will be supplied by the parasitic heater 140 as required based on the load on the fuel cell 102. In other words, the amount of O₂ generated by the oxygen supply 114 may be controlled by controlling the amount of heat supplied to the oxygen supply by the parasitic heater 140.

Turning to the manner in which the exemplary system 100 stores fuel cell reaction byproducts and suppresses heat, the heat from the fuel cell reaction may be used to drive endothermic reactions of the byproducts and materials that are stored in the waste products storage device 116. More specifically, in the exemplary system where the byproducts are H₂O and CO₂, the waste products storage device 116 includes a reaction chamber 158 in which an absorbent material 160 is stored. As used herein, the phrase “absorbent material” means a material that efficiently absorbs H₂O and CO₂ in endothermic fashion. Suitable materials include metals which have a strong tendency to oxidize (e.g. calcium (Ca), strontium (Sr), magnesium (Mg) and aluminum (Al)) and metal oxides (e.g. calcium oxide (CaO), strontium oxide (SrO), magnesium oxide (MgO) and aluminum oxide (Al₂O₃)). Exemplary endothermic reactions include H₂O+CaO→Ca(OH)₂; CO₂+CaO→CaCO₃; H₂O+Ca→CaO+H₂; H₂O+CO₂2H⁺+HCO₃⁻ (aq.). The products of these reactions remain within the reaction chamber 158 in solid or liquid form.

The waste products storage device 116 should also be thermally connected to the heat exchanger 118 so that excess heat from the fuel cell 102 can be used to drive the endothermic reaction in the waste products storage device. This may be accomplished by positioning the heat exchanger 118 and waste product storage device 116 in physical contact with one another, or by thermally connecting them to one another with a heat pipe or other heat conduction pathway. Infrared radiation from the heat exchanger 118 may also be used to heat the contents of the waste products storage device 116.

There are a variety of advantages associated with storing the byproducts in this manner. By way of example, but not limitation, fuel cell systems with the present waste products storage device do not produce the exhaust associated with conventional fuel cell systems. As such, they are especially useful in closed systems, including some military applications, where the exhaust from the fuel cell cannot be vented. They are also useful in electronic applications, where the condensation exhaust with high levels of humidity can produce significant condensation. The waste products storage arrangement also consumes much of the heat from the fuel cell reaction and, as a result, the extensive insulation associated with conventional fuel cells in not required.

The waste products storage device 116 may also be used to return H₂ and any unused fuel to the anode inlet line 126, thereby increasing the overall efficiency of the system. The H₂ and unused fuel pass through a tube 162 to the valve 128. In the exemplary implementation, a selective membrane 163 (such as a palladium-based membrane) is positioned within the waste product storage device 116 at the inlet to the tube 162. The selective membrane 163 allows only the H₂ and unused fuel to enter the tube 162.

There are also many instances where it is desirable to heat the reactants before they reach the fuel cell 102 and, to that end, the exemplary system 100 includes the aforementioned heat exchanger 118 (FIG. 1). Reactant pre-heating prevents the reactants, which may be at a temperature that is less than the operating temperature of the fuel cell 102, from cooling the fuel cell. Suitable heat exchangers include microchannel heat exchangers, cross flow microchannel heat exchangers, “Swiss roll” heat exchangers, and metal foam heat exchangers. The heat exchanger 118 receives heated byproducts from the anode and cathode by way of the inlet lines 154 and 155. After traveling through the heat exchanger 118, the byproducts are transported to the waste products storage device 116 by way of the outlet line 156.

Although the materials, dimensions, and configuration of the fuel cells in the exemplary fuel cell systems will depend upon the type of fuel cell (e.g. SOFC, molten carbonate fuel cell, etc.) and intended application, and although the present inventions are not limited to any particular materials, dimensions, configuration or type, exemplary fuel cells are described below. The exemplary fuels cells are relatively small (e.g. about 10 μm×10 μm to about 10 cm×10 cm) SOFCs. The exemplary fuel cells are also preferably “thin” (i.e. between about 0.3 to 2000 μm thick). The anodes are preferably a porous, ceramic and metal composite (also referred to as “cermet”) film that is about 0.1 to 500 μm thick. Suitable ceramics include samaria-doped ceria (“SDC”), gadolinia-doped ceria (“GDC”) and yttria stabilized zirconia (“YSZ”) and suitable metals include nickel and copper. The cathodes are preferably a porous ceramic film that is about 0.1 to 500 μm thick. Suitable ceramic materials include samarium strontium cobalt oxide (“SSCO”), lanthanum strontium manganate, and bismuth copper substituted vanadate. The electrolytes are preferably a non-porous ceramic film, such as SDC, GDC or YSZ, that is about 0.1 to 1000 μm thick, depending on the material.

The exemplary fuel cell system 100 may be incorporated into a wide variety of power consuming apparatus. Examples of power consuming apparatus include, but are not limited to, information processing devices such as notebook personal computers (“PCs”), handheld PCs, laptop PCs, and personal digital assistants (“PDAs”), communication devices such as mobile telephones, wireless e-mail appliances and electronic books, video games and other toys, and audio and video devices such as compact disk players and video cameras. Other electronic devices include portable test systems, portable projectors, and portable televisions such as portable flat panel televisions. The exemplary fuel cell assembly 100 may also be used in military, high altitude and undersea applications such as, for example, communication devices, thermal imaging devices, night vision device surveillance devices, chemical detection devices, search and rescue apparatus, and undersea mines.

Referring to FIG. 5, an exemplary apparatus 200 includes a fuel cell system 100 and a power consuming device 202 that is powered by the fuel cell system 100. The exemplary power consuming device refers to any or all devices within the particular apparatus than consume electrical power. The fuel cell system 100 may be removably inserted into the exemplary apparatus 200 and, to that end, the exemplary apparatus includes a pair of electrical contacts 204a and 204b that will mate with the fuel cell system electrical contacts 124a and 124b.

Another exemplary fuel cell system, which is generally represented by reference numeral 100a in FIG. 6, is configured for use in those instances where ambient air is available as an oxidant source. The exemplary fuel cell system 100a is substantially similar to the fuel cell system 100 illustrated in FIG. 1 and similar elements are represented by similar reference numerals. The fuel cell system 100a suppresses heat and does not emit byproducts, for example, through the use of endothermic reactions of the byproducts and materials that are stored in the waste products storage device 116. Here, however, the oxidant supply 114a is simply a vent or a vent and fan arrangement that draws ambient air and the heaters 140 and 148 are not required. The exemplary fuel cell system 100a is especially useful in those instances where ambient air with a suitable amount of O₂ is available, and the suppression of heat and/or humid exhaust is important. Consumer electronic devices are examples of devices that may be powered by the exemplary fuel cell system 100a.

Another exemplary fuel cell system, which is generally represented by reference numeral 100b in FIG. 7, is configured for use in those instances where ambient air is not available as an oxidant source, but the emission heat and/or humid exhaust is acceptable, such as various high altitude and underwater applications. The exemplary fuel cell system 100b is substantially similar to the fuel cell system 100 illustrated in FIG. 1 and similar elements are represented by similar reference numerals. The fuel cell system 100b includes, for example, an oxidant supply 114 which produces O₂ by decomposing an oxygen producing material 134, such as an inorganic oxygen containing salt. Here, however, the waste products storage device 116 is replaced by a vent 164 that simply vents the byproducts out of the housing 122. In those instances where the fuel cell system 100b is located within a host device, the host device will typically have a corresponding vent to transfer exhaust from the vent 164 out of the host device. A fuel recirculation system 166, which returns H₂ and unused fuel to the anode inlet line 126, thereby increasing the overall efficiency of the system, may also be provided.

It should be noted here that the exemplary fuel cell systems described above with reference to FIGS. 1-7 may also be configured such that the fuel supply 112, oxidant supply 114 and/or waste products storage device 116 may be removed and replaced. Such an arrangement allows the fuel cell systems to be quickly and easily recharged. For example, the fuel supply 112, oxidant supply 114 and/or waste products storage device 116 may be in the form of cartridges that have connectors which are configured to mate with corresponding connectors within the housing 122. With respect to the oxidant supply 114, the heaters 140 and 148 may be a permanent part of the fuel cell system, or part of the replaceable cartridge (with corresponding electrical and fluidic connectors added thereto).

Although the present inventions have been described in terms of the preferred embodiments above, numerous modifications and/or additions to the above-described preferred embodiments would be readily apparent to one skilled in the art. It is intended that the scope of the present inventions extend to all such modifications and/or additions.

1. An apparatus, comprising:
a fuel cell; and
an oxygen supply, operably connected to the fuel cell, including an inorganic oxygen containing salt that decomposes into oxygen and a non-volatile salt.

2. An apparatus as claimed in claim 1, wherein the fuel cell comprises a solid oxide fuel cell.

3. An apparatus as claimed in claim 1, further comprising:
a heater in thermal communication with the inorganic oxygen containing salt.

4. An apparatus as claimed in claim 1, wherein the inorganic oxygen containing salt comprises a metal chlorate that decomposes into oxygen and a metal chloride.

5. An apparatus as claimed in claim 1, wherein the inorganic oxygen containing salt is stored within the oxygen supply in solid form.

6. An apparatus as claimed in claim 1, further comprising:
a fuel supply operably connected to the fuel cell.

7. An apparatus as claimed in claim 6, further comprising:
a housing defining an interior, in which the fuel cell, fuel supply and oxygen supply are located, and an exterior; and
first and second electrical contacts, operably connected to the fuel cell, associated with the exterior of the housing.

8. An apparatus as claimed in claim 6, further comprising:
a housing in which the fuel cell, fuel supply and oxygen supply are located; and
a waste products storage device, operably connected to the fuel cell, located within the housing.

9. A method, comprising the steps of:
decomposing an inorganic oxygen containing salt into oxygen and a non-volatile salt; and
supplying the oxygen to a fuel cell.

10. A method as claimed in claim 8, wherein the step of decomposing an inorganic oxygen containing salt comprises decomposing a metal chlorate into oxygen and a metal chloride.

11. A method as claimed in claim 8, further comprising the step of:
supplying heat to the inorganic oxygen containing salt.

12. A method as claimed in claim 8, further comprising the step of:
storing the inorganic oxygen containing salt in solid form.

13. A method as claimed in claim 8, further comprising the steps of:
supplying fuel to the fuel cell; and
transferring byproducts from a fuel cell reaction to a waste products storage device.

14. An apparatus, comprising:
a fuel cell; and
means, operably connected to the fuel cell, for decomposing an inorganic oxygen containing salt into oxygen and a non-volatile salt.

15. An apparatus as claimed in claim 14, wherein the fuel cell comprises a solid oxide fuel cell.

16. An apparatus as claimed in claim 14, further comprising:
a fuel supply operably connected to the fuel cell.

17. An apparatus as claimed in claim 16, further comprising:
a housing defining an interior, in which the fuel cell, fuel supply and means for decomposing an inorganic oxygen containing salt are located, and an exterior; and
first and second electrical contacts, operably connected to the fuel cell, associated with the exterior of the housing.

18. An apparatus as claimed in claim 16, further comprising:
a housing in which the fuel cell, fuel supply and means for decomposing an inorganic oxygen containing salt are located; and
a waste products storage device, operably connected to the fuel cell, located within the housing.

19. An apparatus, comprising:
a power consuming device; and
a fuel cell system, operably connected to the power consuming device, including
a fuel cell,
a fuel supply operable connected to the fuel cell, and
an oxygen supply, operably connected to the fuel cell, including an inorganic oxygen containing salt that decomposes into oxygen and a non-volatile salt.

20. An apparatus as claimed in claim 19, wherein the power consuming device includes at least one electrical contact, the fuel cell system includes at least one electrical contact, and the power consuming device and fuel cell system are respectively configured such that the fuel cell electrical contact will mate with the power consuming device electrical contact when the fuel cell system is inserted into the electrical device.

21. An apparatus, comprising:
a fuel cell;
a waste products storage device, operably connected to the fuel cell, including an absorbent material that endothermically reacts with byproducts from the fuel cell.

22. An apparatus as claimed in claim 21, wherein the fuel cell comprises a solid oxide fuel cell.

23. An apparatus as claimed in claim 21, wherein the absorbent material comprises at least one of a metal and a metal oxide.

24. An apparatus as claimed in claim 21, further comprising:
a housing defining an interior, in which the fuel cell and waste products storage device are located, and an exterior; and
first and second electrical contacts, operably connected to the fuel cell, associated with the exterior of the housing.

25. An apparatus as claimed in claim 24, further comprising:
a fuel supply, operably connected to the fuel cell, located within the housing.

26. An apparatus as claimed in claim 24, further comprising:
an oxidant supply, operably connected to the fuel cell, located within the housing.

27. An apparatus as claimed in claim 26, wherein the oxidant supply includes an inorganic oxygen containing salt that decomposes into oxygen and a non-volatile salt.

28. An apparatus as claimed in claim 21, wherein the product of a reaction between the absorbent material and the fuel cell byproducts is stored within the waste products storage device.

29. A method of operating a fuel cell, comprising the steps of:
transferring fuel cell reaction byproducts to a waste products storage device; and
mixing the fuel cell reaction byproducts with an absorbent material that endothermically reacts with the fuel cell reaction byproducts.

30. A method as claimed in claim 29, further comprising the step of:
storing a product of a reaction between the absorbent material and the fuel cell reaction byproducts within the waste products storage device.

31. A method as claimed in claim 29, wherein the fuel cell is located within a housing, the method further comprising the step of:
storing a product of a reaction between the absorbent material and the fuel cell reaction byproducts within the waste products storage device within the housing.

32. An apparatus, comprising:
a fuel cell;
means, operably connected to the fuel cell, for receiving fuel cell reaction byproducts, using the fuel cell reaction byproducts in an endothermic reaction, and storing all products of the endothermic reaction.

33. An apparatus as claimed in claim 32, wherein the fuel cell comprises a solid oxide fuel cell.

34. An apparatus as claimed in claim 32, further comprising:
a housing defining an interior, in which the fuel cell and means for receiving fuel cell reaction byproducts are located, and an exterior; and
first and second electrical contacts, operably connected to the fuel cell, associated with the exterior of the housing.

35. An apparatus as claimed in claim 32, further comprising:
a fuel supply, operably connected to the fuel cell, located within the housing.

36. An apparatus as claimed in claim 32, further comprising:
an oxidant supply, operably connected to the fuel cell, located within the housing.

37. An apparatus as claimed in claim 36, wherein the oxidant supply includes an inorganic oxygen containing salt that decomposes into oxygen and a non-volatile salt.

38. An apparatus, comprising:
a power consuming device; and
a fuel cell system, operably connected to the power consuming device, including
a fuel cell,
a waste products storage device, operably connected to the fuel cell, including an absorbent material that endothermically reacts with byproducts from the fuel cell.

39. An apparatus as claimed in claim 38, wherein the power consuming device includes at least one electrical contact, the fuel cell system includes at least one electrical contact, and the power consuming device and fuel cell system are respectively configured such that the fuel cell electrical contact will mate with the power consuming device electrical contact when the fuel cell system is inserted into the electrical device.

40. An apparatus as claimed in claim 38, wherein the fuel cell system includes a fuel supply and an oxidant supply.
